(19) United States
(12) Patent Application Publication
(10) Pub. No.: US 2007/0063943 A1
(43) Pub. Date: Mar. 22, 2007

(54) Display apparatus

(75) Inventors: Shinya Tanaka, Kobe (JP); Kiyoshi Hamatani, Kobe (JP)

Correspondence Address: OLIFF & BERRIDGE, PLC, P.O. BOX 19928, ALEXANDRIA, VA, 22320, US

(73) Assignee: FUJITSU TEN LIMITED, Hyogo-ku (JP)

(21) Appl. No.: 11/520,748

(22) Filed: Sep. 14, 2006

(30) Foreign Application Priority Data
Sep. 21, 2005 (JP) 2005-274790
Mar. 15, 2006 (JP) 2006-071033

(51) Int. Cl. G09G 3/36

(52) U.S. Cl. 345/87

(57) ABSTRACT

A display apparatus includes a display panel that displays individual images in a plurality of viewing directions on a common screen, a parallax barrier that makes the individual images respectively visible from the plurality of viewing directions, a light guide plate provided on a back surface of the display panel, and a plurality of light-emitting portions arranged at one or more sides of the light guide plate. The plurality of light-emitting portions are arranged in a line in a thickness direction of the light guide plate.

### BACKGROUND OF THE INVENTION

1. Field of the Invention

This invention generally relates to display apparatuses, and more particularly, to a display apparatus having a light-emitting portion.

2. Description of the Related Art

In recent years, in-vehicle liquid crystal display apparatuses have been rapidly widespread so as to watch car navigation maps or video images in vehicles. As a so-called multi-view display having a common display screen, on which different images are respectively visible from different viewing directions (view angles), there has been known a multi-view display with a liquid crystal panel having a parallax barrier on the front side thereof. Different information (images) can be displayed on the right and left sides of the display screen by separating directions of lights through a backlight on a pixel basis (for example, as disclosed in Japanese Patent Application Publication No. 2005-78080). Such display is mounted on a vehicle, allowing the front-seat passenger to watch a TV program or another image, while the driver is checking a navigation map image.

For example, the in-vehicle display apparatus is, in most cases, located in a dashboard part between the driver and the front-seat passenger. The in-vehicle apparatus is needed to have a determined size, as viewed from the front surface. However, the display screen is demanded to be large. In order to make the display screen large in consideration of the above limitation, the width of the chassis provided at the sides of the display screen needs to be narrowed, when the chassis is viewed from the front surface. Meanwhile, the brightness of the backlight of the display apparatus also needs to be increased. For example, in a case where a multi-view display is employed as the display apparatus, the light emitted from the backlight is sorted into left and right images. Hence, the brightness of the backlight has to be enhanced to maintain the brightness of the left and right images. However, the brightness of the fluorescent tube provided at sides of a light guide plate, which is the backlight, has to enhance the brightness of the backlight. For example, if the size of the fluorescent tube is increased, the width of the chassis provided in the periphery of the display screen becomes larger, when the chassis is viewed from the front surface.

### SUMMARY OF THE INVENTION

The present invention has been made in view of the above circumstances and provides a display apparatus in which a width of a chassis provided at sides of a display screen can be narrowed.

According to one aspect of the present invention, there is provided a display panel that displays individual images in a plurality of viewing directions on a common screen; a parallax barrier that makes the individual images respectively visible from the plurality of viewing directions; a light guide plate provided on a back surface of the display panel; and a plurality of light-emitting portions arranged at one or more sides of the light guide plate. The plurality of light-emitting portions are arranged in a line in a thickness direction of the light guide plate. It is therefore possible to reduce the width of the chassis of the display screen, as viewed from the front surface.

According to another aspect of the present invention, there is provided a display apparatus including: a display panel that displays individual images in a plurality of viewing directions on a common screen; a parallax barrier that makes the individual images respectively visible from the plurality of viewing directions; a light guide plate provided on a back surface of the display panel; and a plurality of light-emitting diodes arranged at opposing sides of the light guide plate, wherein light axes of the plurality of light-emitting diodes arranged at one side of the opposing sides are shifted from the light axes of the plurality of light-emitting diodes arranged at the other side of the opposing sides.

### BRIEF DESCRIPTION OF THE DRAWINGS

Preferred exemplary embodiments of the present invention will be described in detail with reference to the following drawings, wherein:

FIG. 1 is a view illustrating a basic configuration of a multi-view display apparatus in accordance with a first embodiment of the present invention;

FIG. 2 is a perspective view showing an example in which the display apparatus is applied to a vehicle in accordance with the first embodiment of the present invention;

FIG. 3 is a functional block diagram of the display apparatus in accordance with the first embodiment of the present invention;

FIG. 4 is a functional block diagram showing a configuration of a controller in accordance with the first embodiment of the present invention;

FIG. 5 is a functional block diagram of first and second image quality adjusting circuits in accordance with the first embodiment of the present invention;

FIG. 6 is a functional block diagram of an image outputting portion in accordance with the first embodiment of the present invention;

FIG. 7 is a view illustrating a cross-sectional configuration and effects of a liquid crystal panel in accordance with the first embodiment of the present invention;

FIG. 8 is a front view of the liquid crystal panel in accordance with the first embodiment of the present invention;

FIG. 9 is a circuit diagram of a TFT substrate in accordance with the first embodiment of the present invention;

FIG. 10 is an external view of the display apparatus in accordance with the first embodiment of the present invention in a state where the display stands up with respect to a main body;

FIG. 11A is a front view of the display;

FIG. 11B is a front view of the display shown in FIG. 11A with a chassis;

FIG. 11C is a cross-sectional view taken along the line A-A shown in FIG. 11A;

FIG. 11D is a cross-sectional view taken along the line B-B shown in FIG. 11A;

FIG. 12 shows the positional relationship of a light guide plate and fluorescent tubes;

FIG. 13A is a view of a part C shown in FIG. 11A, as viewed from the left;

FIG. 13B is a view of a part D shown in FIG. 11A, as viewed from the right;

FIG. 14 is a cross-sectional view of the display that employs white LEDs in accordance with a second exemplary embodiment of the present invention; and

FIG. 15 is a front view of a backlight portion that employs white LEDs in accordance with the second exemplary embodiment of the present invention.

### DESCRIPTION OF THE PREFERRED EMBODIMENTS

A description will now be given, with reference to the accompanying drawings, of exemplary embodiments of the present invention.

### First Exemplary Embodiment

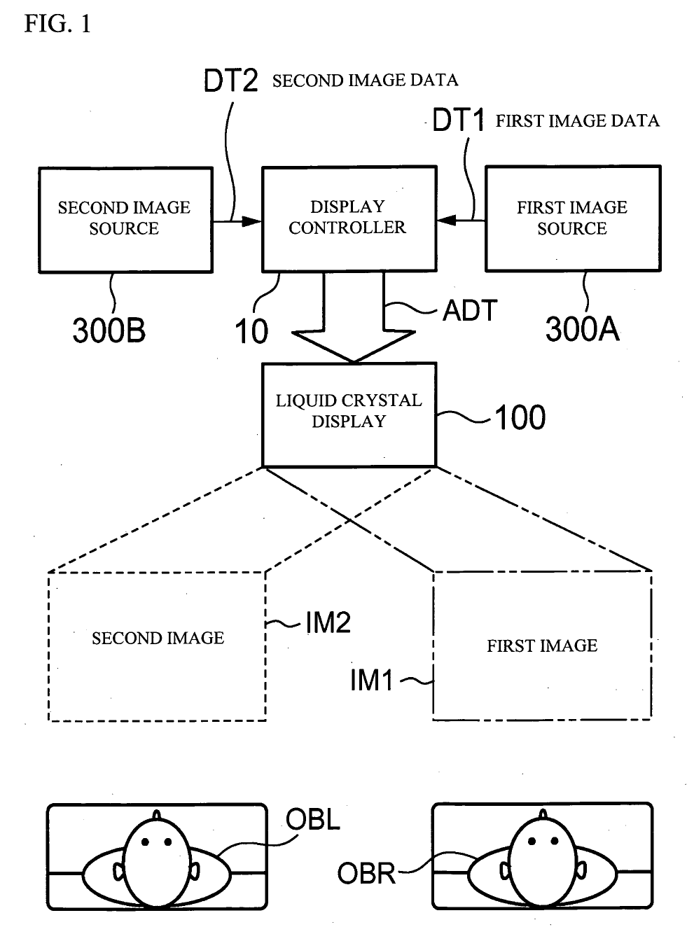

FIG. 1 is a view illustrating a basic configuration of a multi-view display apparatus in accordance with a first exemplary embodiment of the present invention. In the first exemplary embodiment, a description will be given of an example in which the display apparatus is mounted in a vehicle. Referring now to FIG. 1, the multi-view display apparatus includes a display controller 10 that serves as a display control portion and a display 100 that serves as a display portion. To the display controller 10, image data DT1 is supplied from a first image source 300A that servers as a supply source, and at the same time, image data DT2 is also supplied from a second image source 300B that servers as a supply source. Then, image data ADT, which is composed of the first image data DT1 and the second image data DT2, is output to the common display 100. The configuration of the display controller 10 will be described later in detail. The first image source 300A and the second image source 300B are respectively composed of a camera, TV receiver, DVD reproducing portion, HD reproducing portion, navigation portion, and the like, as will be described later.

The display 100 includes a liquid crystal panel, backlight, parallax barrier, and the like, as will also be described later. A first image IM1 based on the first image data DT1 and a second image IM2 based on the second image data DT2 are displayed on a common display screen so that an observer OBR can watch the first image IM1 from a right-hand direction and an observer OBL can watch the second image IM2 from a left-hand direction. The configuration of the display 100 will also be described later in detail.

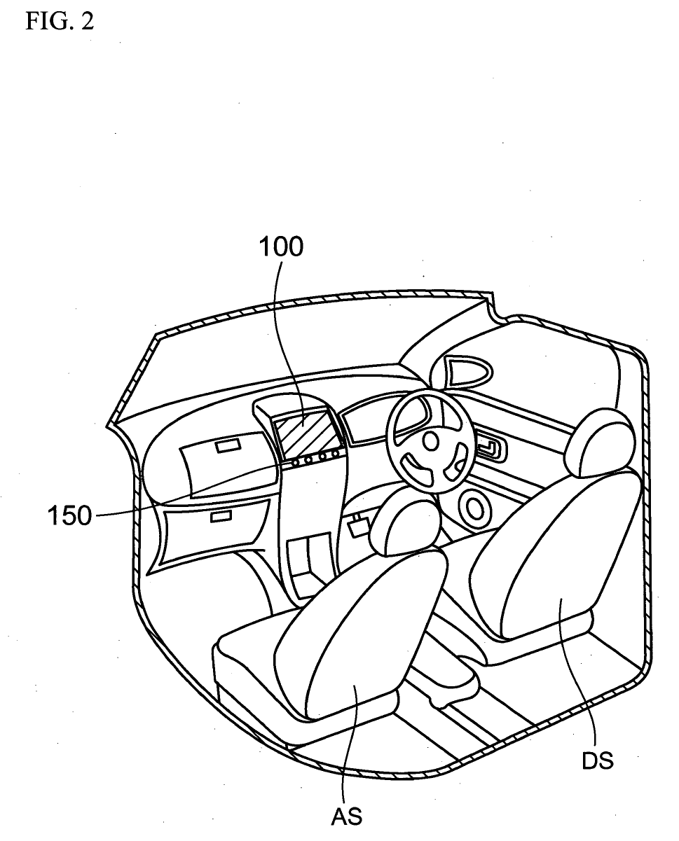

FIG. 2 is a perspective view showing an example in which the display apparatus employed in the first exemplary embodiment of the present invention is applied to a vehicle. Referring to FIG. 2, the display 100 is arranged between a driver's seat DS and a front passenger's seat AS in a dashboard area of the vehicle. In addition, the display 100 is provided with an operating portion 150 so as to manually operate the display apparatus. According to an exemplary embodiment shown in FIG. 2, a passenger who sits on the driver's seat DS corresponds to the above-described observer OBR, and another passenger who sits on the front passenger's seat AS corresponds to the above-described observer OBL. Those passengers are able to simultaneously watch individual images, namely, the first image IM1 and the second image IM2, which are respectively different and displayed on the display 100, from the driver's seat DS and from the front passenger's seat AS.

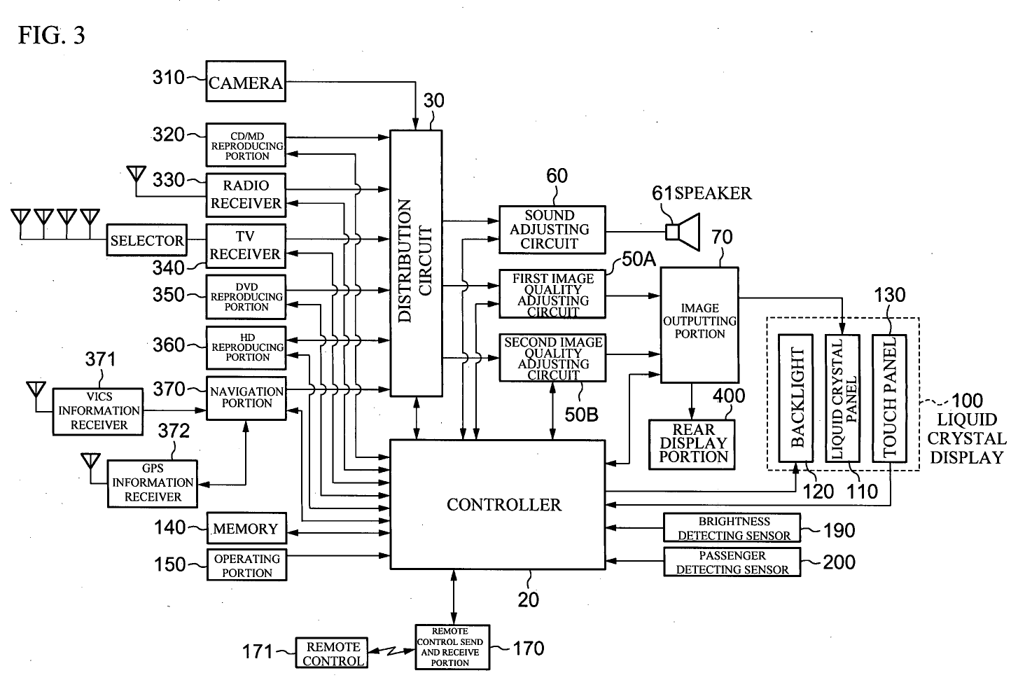

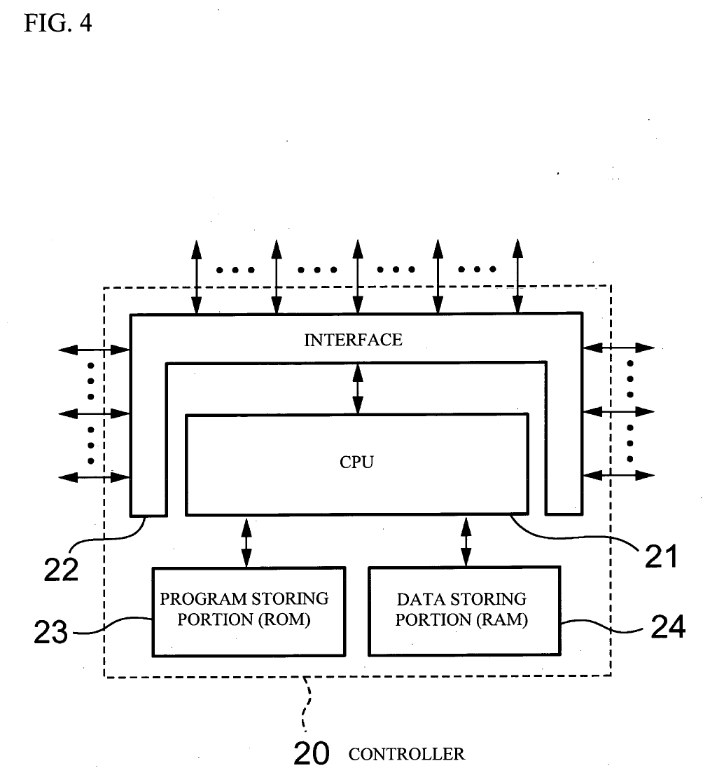

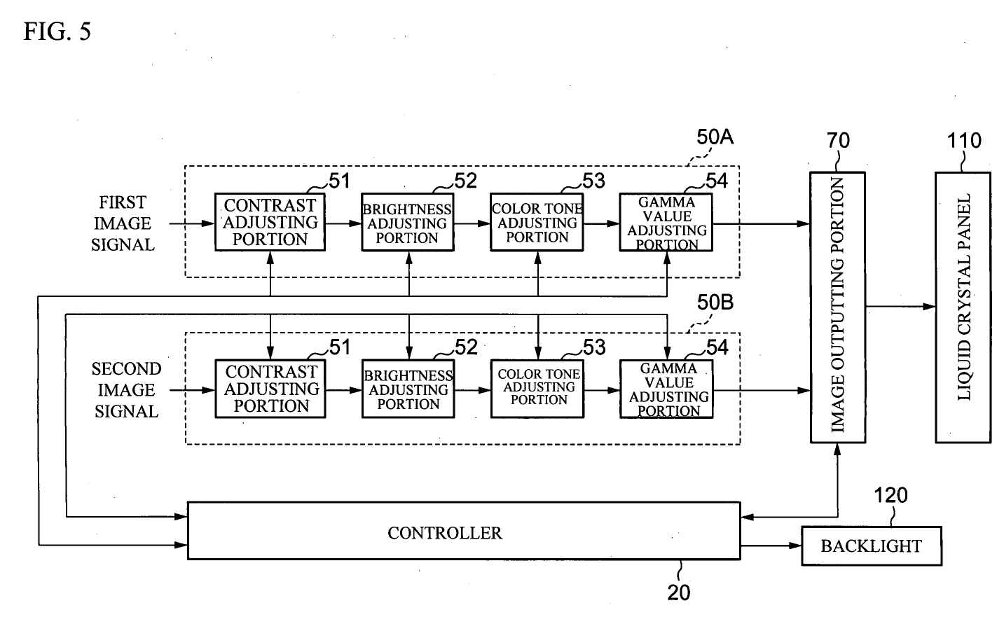

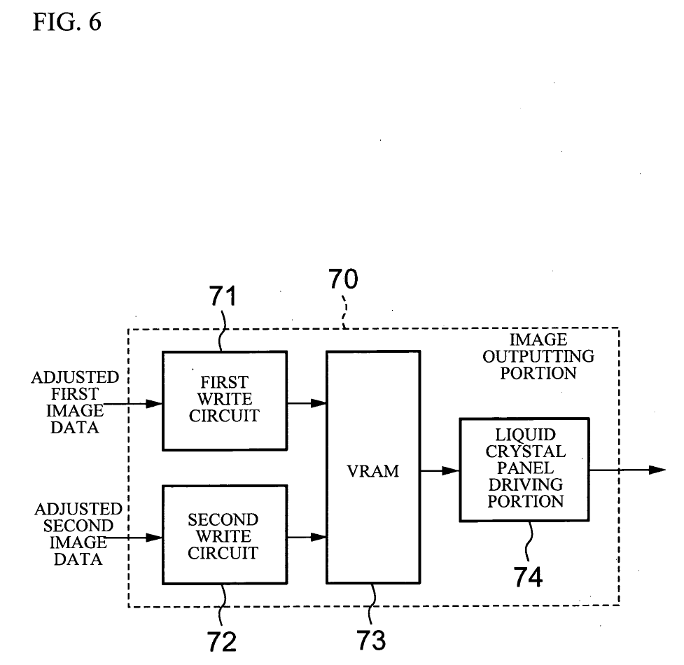

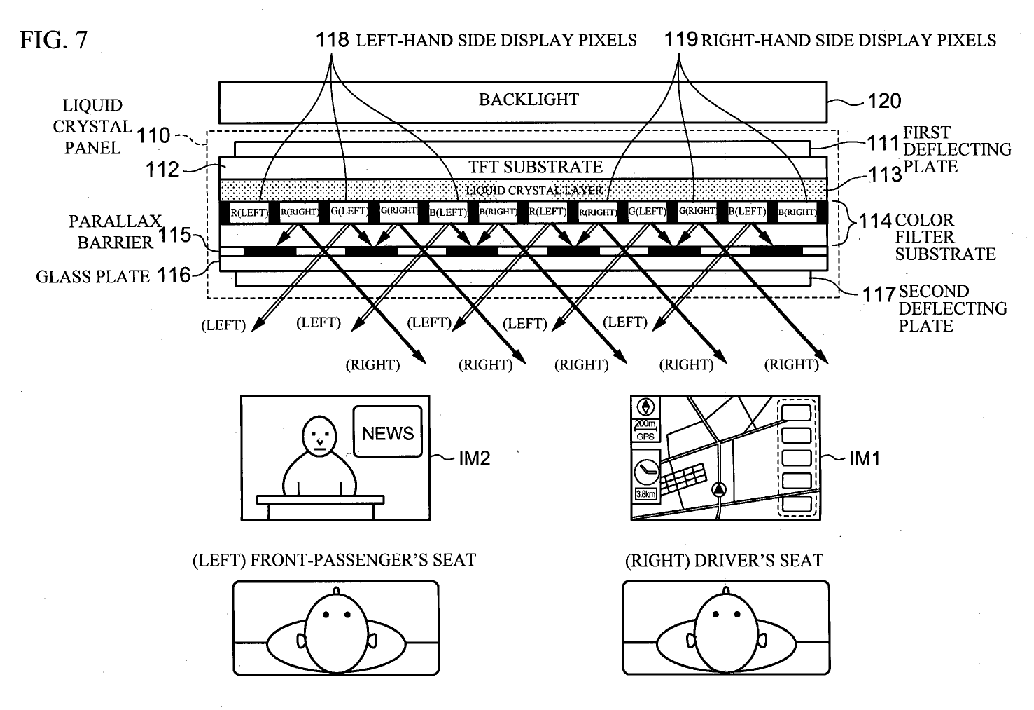

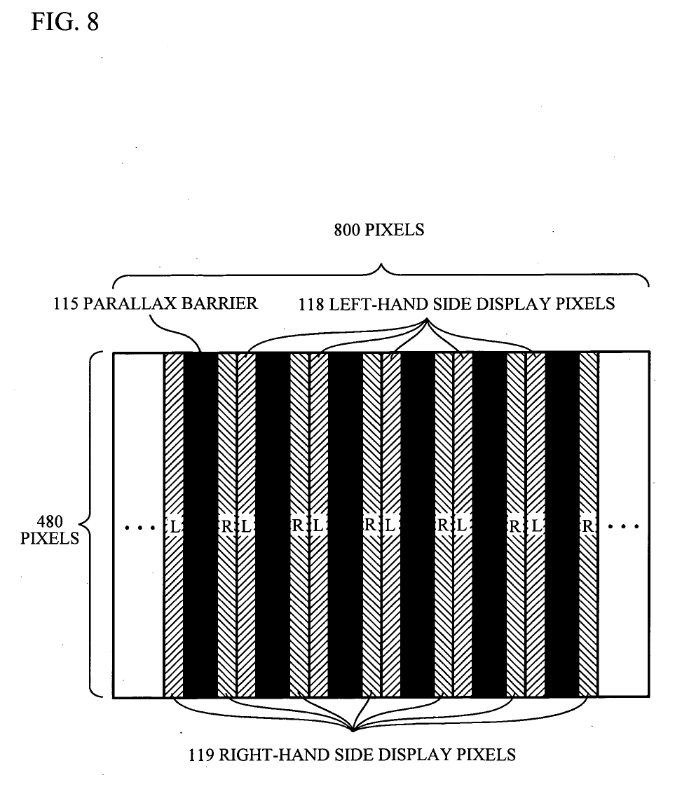

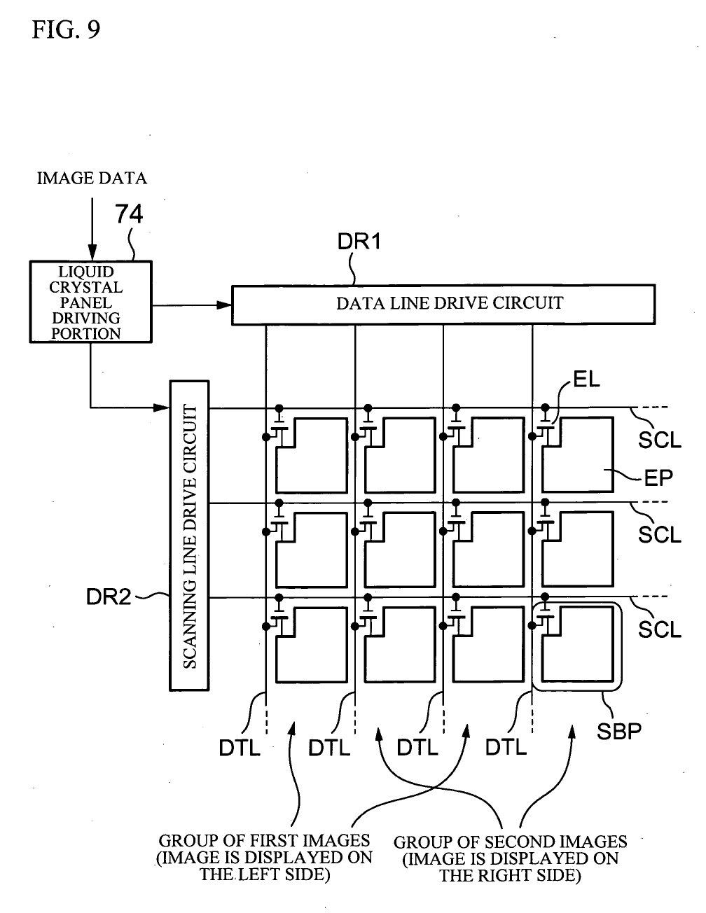

FIG. 3 through FIG. 9 illustrate specific configurations of the display apparatus in accordance with the first exemplary embodiment of the present invention. FIG. 3 is a functional block diagram of the display apparatus. FIG. 4 is a functional block diagram showing a configuration of the controller. FIG. 5 is a functional block diagram of first and second image quality adjusting circuits. FIG. 6 is a functional block diagram of an image outputting portion. FIG. 7 is a view illustrating a cross-sectional configuration and effects of a liquid crystal panel. FIG. 8 is a front view of the liquid crystal panel. FIG. 9 is a circuit diagram of a TFT substrate.

Referring now to FIG. 3, the display apparatus includes the display 100, a controller 20, a distribution circuit 30, a first image quality adjusting circuit 50A, a second image quality adjusting circuit 50B, an image outputting portion 70, and the like. The display controller 10 includes the controller 20, the distribution circuit 30, the first image quality adjusting circuit 50A, the second image quality adjusting circuit 50B, the image outputting portion 70, and the like.

Referring now to FIG. 4, the controller 20 includes a processor (CPU) 21, an interface 22, a ROM 23, a RAM 24, and the like. The controller 20 controls the display apparatus according to a program stored in the ROM 23 in a comprehensive manner. Also, the controller 20 controls a visible range of the first image IM1 and a visible range of the second image IM1, which are separated from each other by superimposing the first image IM1 and the second image IM2 to be displayed on the display 100, by adjusting the image quality of at least one of the first image IM1 and the second image IM2 to have a given range.

The controller 20 is connected to a camera 310, a compact disc/mini disc (CD/MD) reproducing portion 320, a radio receiver 330, a TV receiver 340, a digital versatile disc (DVD) reproducing portion 350, a hard disc (HD) reproducing portion 360, a navigation portion 370, and the like, so as to send and receive data and control the afore-described components, which are mounted on a vehicle and respectively serve as supply sources supplying images and sounds, as illustrated in FIG. 3. The camera 310 captures images of surroundings and the like of the vehicle. The CD/MD reproducing portion 320 reproduces music or images. The radio receiver 330 receives radio waves via an antenna. The TV receiver 340 receives TV waves via an antenna through a selector 341. The DVD reproducing portion 350 reproduces music information and images in a DVD. The HD reproducing portion 360 reproduces images and music information stored in a HD. The navigation portion 370 outputs maps or route guide images on the basis of road information received by a VICS information receiver 371 and geographic information received by a GPS information receiver 372.

Additionally, the controller 20 is also connected to an external memory 140, the operating portion 150, a remote control send and receive portion 170, a brightness detecting sensor 190, a passenger detecting sensor 200, and the like, and enables various controls on the basis of various kinds of data obtained from the afore-mentioned components. The external memory 140 stores various kinds of data. The operating portion 150 is provided for operating the display apparatus. The remote control send and receive portion 170 sends and receives infrared signals or wireless signals between a remote controller 171 provided for controlling the display apparatus remotely. The brightness detecting sensor 190 is composed of a light switch or a light sensor to detect the brightness inside the vehicle. The passenger detecting sensor 200 is composed of a pressure-sensitive sensor or the like on the driver's seat or the front passenger's seat to detect a passenger in the vehicle.

The distribution circuit 30, as illustrated in FIG. 3, distributes sound data and image data supplied from the above-described camera 310, the CD/MD reproducing portion 320, the radio receiver 330, the TV receiver 340, the DVD reproducing portion 350, the HD reproducing portion 360, the navigation portion 370, and the like, to the first image quality adjusting circuit 50A or the second image quality adjusting circuit 50B, according to a control instruction issued by the controller 20.

A sound adjusting circuit 60 adjusts the sound data supplied from the distribution circuit 30 to output to a speaker 61, as illustrated in FIG. 3.

Each of the first image quality adjusting circuit 50A and the second image quality adjusting circuit 50B, by reference to FIG. 5, includes a contrast adjusting portion 51, a brightness adjusting portion 52, a color tone adjusting portion 53, a gamma value adjusting portion 54, and the like, and respectively adjusts the image qualities (contrast, brightness, color tone, and gamma value) of the image qualities of the first image data and the second image data, in response to the control instruction issued by the controller 20.

Referring now to FIG. 6, the image outputting portion 70 includes a first write circuit 71, a second write circuit 72, a video RAM (VRAM) 73, a liquid crystal panel driving portion 74, and the like. The first image data and the second image data, image qualities of which have respectively been adjusted by the first image quality adjusting circuit 50A and the second image quality adjusting circuit 50B, are respectively written into the first write circuit 71 and the second write circuit 72. The first write circuit 71 and the second write circuit 72 respectively write the first image data and the second image data, the image qualities of which are respectively adjusted by the first image quality adjusting circuit 50A and the second image quality adjusting circuit 50B, into given addresses of the VRAM 73, in order to superimpose such adjusted first image data and such adjusted second image data.

The VRAM 73 retains the image data on which the first image data and the second image data are superimposed. Such superimposed image data corresponds to respective pixels of the display 100. The liquid crystal panel driving portion 74 is a circuit that drives a liquid crystal panel 110, and also drives the corresponding pixels of the liquid crystal panel 110, on the basis of the superimposed image data retained in the VRAM 73. The liquid crystal panel 110 will be described later in detail.

The display 100 includes the liquid crystal panel 110, a backlight portion 120, a touch panel 130, and the like, as illustrated in FIG. 3. The backlight portion 120 sheds illuminated lights from the backside of the liquid crystal panel 110. The touch panel 130 is provided for inputting a signal to operate the display apparatus. Here, the touch panel 130 is not shown, yet is formed in a shape of transparent sheet and adhered to the front surface of the liquid crystal panel 110.

Referring now to FIG. 7, the liquid crystal panel 110 has a known structure. Sequentially from the backlight portion 120, there are provided a first deflecting plate 111, a thin film transistor (TFT) substrate 112, a liquid crystal layer 113, a color filter substrate 114 having pixels for three primary colors of RGB, a parallax barrier 115, a glass plate 116, a second deflecting plate 117, and the like.

The above-described liquid crystal panel 110 has a display screen in which, for example, 800 pixels are arranged in a horizontal direction and 480 pixels in a vertical direction, as illustrated in FIG. 7 and FIG. 8. Also, left-hand side display pixels 118 (hereinafter, also referred to as front passenger's display pixel 118) and right-hand side display pixels 119 (hereinafter, also referred to as driver's display pixel 119) are alternately arranged in a horizontal direction of the display screen.

The parallax barrier 115 is formed in a stripe-shaped manner, and includes shielding portions and transmitting portions, as illustrated in FIG. 7 and FIG. 8. The shielding portions are arranged between the left-hand side display pixels 118 and the right-hand side display pixels 119. By providing the parallax barrier 115 on the front surface of the color filter substrate 114, among the illuminated lights that have passed through the left-hand side display pixels 118, only the lights going towards the left side selectively pass through the transmitting portions of the parallax barrier 115. Among the illuminated lights that have passed through the right-hand side display pixels 119, only the lights going towards the right side selectively pass through the transmitting portions of the parallax barrier 115. This makes the first image IM1 visible from the right side (the driver's seat) of the liquid crystal panel 110, and also makes the second image IM2 visible from the left side (the front passenger's side). Here, a similar parallax barrier as disclosed in Japanese Patent Application Publication No. 10-123461 or Japanese Patent Application Publication No. 11-84131 may be employed for the parallax barrier 115.

The TFT substrate 112, by reference to FIG. 9, includes a data line drive circuit DR1, a scanning line drive circuit DR2, vertically arranged scanning lines SCL, horizontally arranged data lines DTL, TFT elements EL, pixel electrodes EP corresponding to the TFT elements EL, and the like, whereas each of the TFT elements EL is formed in each region where each of the scanning lines SCL and each of the data lines DTL are crossed. Sub pixels SBP are formed by regions surrounded by the scanning lines SCL and the data lines DTL, and the sub pixels SBP arranged along each of the data lines DTL are alternately assigned to the left-hand side display pixels 118 and the right-hand side display pixels 119. A drive timing of the data line drive circuit DR1 is controlled by the liquid crystal panel driving portion 74 to control a voltage applied to the pixel electrode EP. A Drive timing of the scanning line drive circuit DR2 is controlled by the liquid crystal panel driving portion 74 to selectively scan the TFT element EL.

FIG. 10 is an external view of the display apparatus in accordance with the first exemplary embodiment of the present invention. The display apparatus is composed of: the display 100 having a display screen 102 and the operating portion 150; and a main body 152 composed of a different chassis from the display 100. The display 100 is used in such a manner that the display 100 is accommodated in a frame 154 provided in the periphery of the front surface of the main body 152. The display 100 can be opened by tilting the display 100, as illustrated in FIG. 10, and the storage media such as a DVD and the like can be operated from the front side of the main body 152.

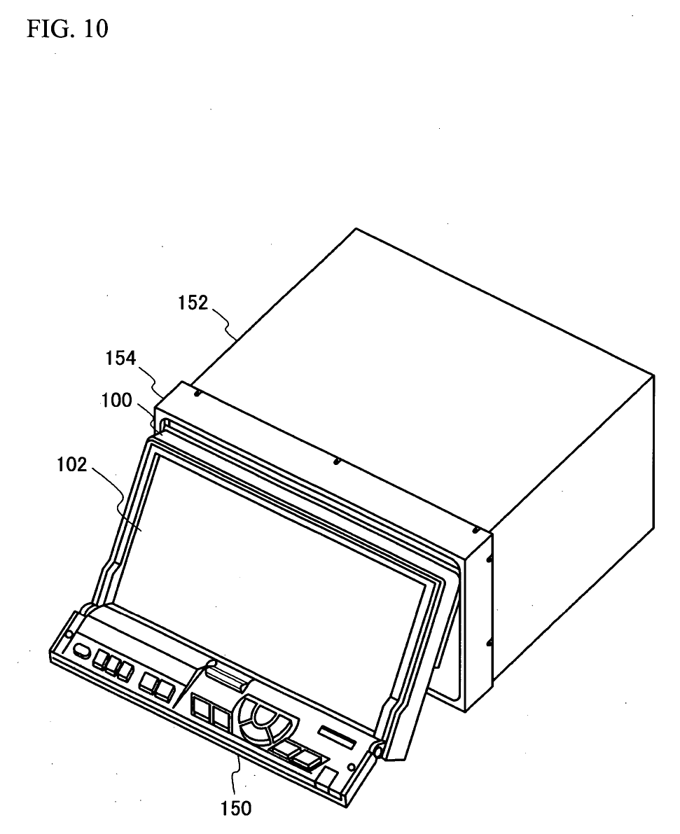

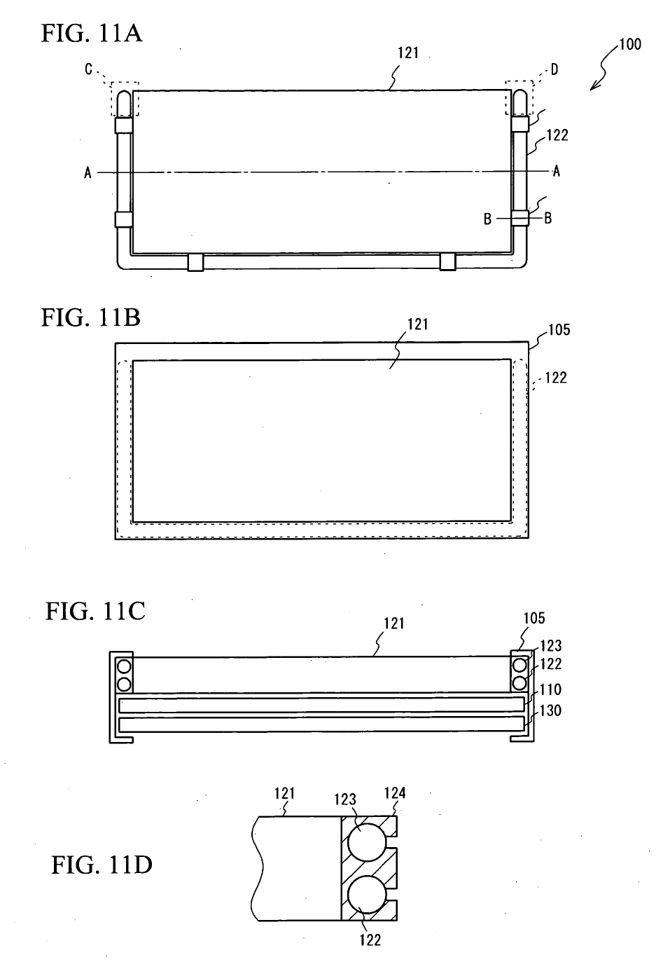

FIG. 11A through FIG. 11D illustrate the display 100 in more details. FIG. 11A is a front view of the display 100 (a chassis 105, the touch panel 130, and the liquid crystal panel 110 are not shown). Fluorescent tubes 122 and 123 are provided at the side of a light guide plate 121 as light-emitting portions. The fluorescent tubes 122 and 123 are secured by securing members 124. FIG. 11B is a front view of the display 100 shown in FIG. 11A with the chassis 105, and the fluorescent tube 122 is indicated by a dotted line. As shown in FIG. 11B, the width viewed from the front surface of the chassis 105 substantially varies depending on each width of the fluorescent tube 122 and 123. FIG. 11C is a cross-sectional view taken along the line A-A shown in FIG. 11A. The liquid crystal panel 110 is provided on the backside of the touch panel 130, and the light guide plate 121 is provided on the backside of the liquid crystal panel 110. The two fluorescent tubes 122 and 123 are arranged at the side of the light guide plate 121. The fluorescent tubes 122 and 123 are located in alignment in backward and frontward directions of the light guide plate 121. The backlight portion 120 is composed of the light guide plate 121 and the fluorescent tubes 122 and 123. The chassis 105 covers the sides of the touch panel 130, the liquid crystal panel 110, the light guide plate 121, and the fluorescent tubes 122 and 123. FIG. 11D is a cross-sectional view taken along the line B-B shown in FIG. 11A. The fluorescent tubes 122 and 123 are secured by the comb-like securing members 129 made of transparent silicon resin.

With such a configuration, the light emitted from the fluorescent tubes 122 and 123 is transmitted through the light guide plate 121, enters the liquid crystal panel 110 from the backside of the liquid crystal panel 110, passes through the touch panel 130, and is emitted to the front surface of the display 100. Here, the cold cathode discharge tubes are employed for the fluorescent tubes 122 and 123. However, the present invention is not limited thereto.

In order increase the brightness of the backlight portion 120, the brightness of the fluorescent tube may be increased with a single fluorescent tube. However, in the afore-mentioned case, the diameter of the fluorescent tube becomes greater and the width of the chassis 105 becomes greater. In consideration of the limitation on the location in a vehicle, for example, the in-vehicle liquid crystal display apparatus needs to be accommodated in a given size, when viewed from the front surface. This decreases the liquid crystal display screen. Meanwhile, when the two fluorescent tubes 122 and 123 are arranged in a line in a width direction, the brightness of the backlight portion 120 can be increased without increasing the width of the chassis 105 as viewed from the front surface thereof.

As shown in FIG. 11A, the two fluorescent tubes 122 and 123 are provided at three sides, that is, at both sides and at the bottom of the light guide plate 121, as viewed from the front surface, and are formed in a substantially U shape. Each of the fluorescent tubes 122 and 123 is made of a bent fluorescent tube. The brightness of the backlight portion 120 can be improved by providing the fluorescent tubes 122 and 123 at as many sides as possible. However, it is expensive to provide the fluorescent tubes 122 and 123 at the four sides, and the fluorescent tubes 122 and 123 provided at the top cause a problem that the width of the top is larger in the chassis 105. Therefore, each of the fluorescent tubes 122 and 123 is made of a bent fluorescent tube to be formed in a substantially U shape. As described, preferably, the fluorescent tubes 122 and 123 are provided at the three sides. Yet, the fluorescent tubes 122 and 123 may be provided at one, two, or four sides or may be partially provided at the sides. The brightness of the backlight portion 120 can be maintained by providing the fluorescent tubes 122 and 123 at at least two of the four sides of the light guide plate 121. In a case where one or more fluorescent tubes are provided at two sides, the fluorescent tubes may be formed in an L shape, or the fluorescent tubes may be provided at one of the sides in a longitudinal direction and at one of the sides perpendicular to the longitudinal direction.

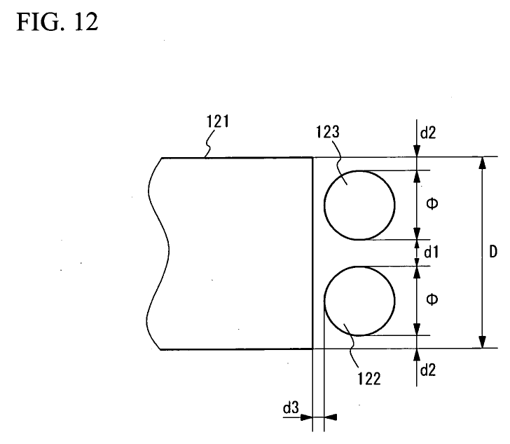

FIG. 12 is a cross-sectional view taken along the line A-A shown in FIG. 11A, and shows the positional relationship of the light guide plate 121 and the fluorescent tubes 122 and 123. In FIG. 12, the same components and configurations in FIG. 11A have same reference numerals. D represents a width of the light guide plate 121, Φ represents a diameter of the fluorescent tubes 122 and 123, d1 represents a width between the fluorescent tubes 122 and 123, d2 represents a protruding amount of the light guide plate 121 from the fluorescent tube 122 or 123 in the front surface direction or in the back surface direction, and d3 represents a distance between the fluorescent tubes 122 and 123 and the light guide plate 121. Φ is set to 2.2 mm, d1, d2, and d3 are respectively set to 0.5 mm. d1, d2, and d3 are values determined by the processing accuracy of the fluorescent tubes 122 and 123. The above-described sizes are not limited to the values mentioned above. The width D of the light guide plate 121 in a thickness direction is greater than a width of (Φ+d1+Φ), which is a total of both widths of the fluorescent tubes 122 and 123 and the distance between the fluorescent tubes 122 and 123. Therefore, most lights emitted from the fluorescent tubes 122 and 123 can enter the light guide plate 121, thereby improving the brightness of the backlight portion 120.

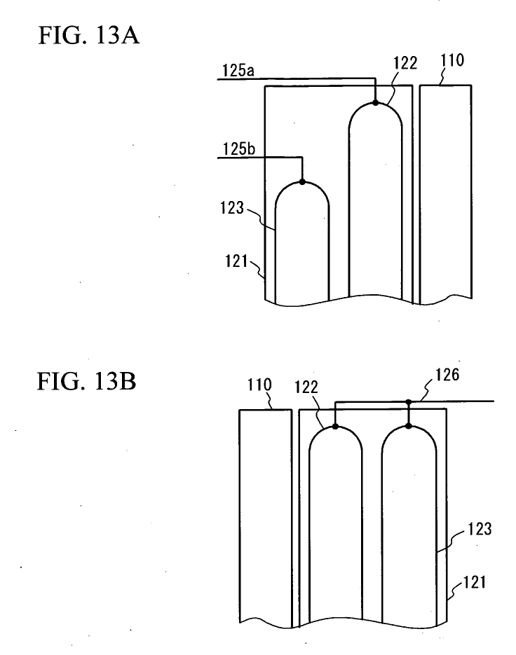

FIG. 13A is a view of a part C shown in FIG. 11A, as viewed from the left. FIG. 13B is a view of a part D shown in FIG. 11A, as viewed from the right. The same components and configurations in FIG. 11A have same reference numerals. Referring to FIG. 13A, the liquid crystal panel 110 is arranged on a right-hand side (front surface side) of the light guide plate 121. The fluorescent tube 123 arranged on the back surface side has a length smaller than that of the fluorescent tube 122. In this manner, the fluorescent tubes 122 and 123 provided on the side of the light guide plate 121 are different in length, as seen in one ends thereof. Electric power lines 125a and 125b respectively connected from cathode electrodes of the fluorescent tubes 122 and 123 are separately connected to the power supply, not shown, on the back surface side. Since the electric power lines 125a and 125b are connected by different fluorescent tubes 122 and 123, it is preferable that the electric power lines 125a and 125b should be provided with a given gap or clearance.

Meanwhile, referring to FIG. 13B, the liquid crystal panel 110 is arranged on a left-hand side of the light guide plate 121. The other ends of the two fluorescent tubes 122 and 123 are substantially located at an identical position in height. An electric power line 126 connected from ground electrodes of the fluorescent tubes 122 and 123 is commonly connected to the ground of the power supply provided on the back surface side.

The fluorescent tubes 122 and 123 are different in length and one of the ends of the fluorescent tubes 122 and 123 is provided at a different position from the other of the ends of the fluorescent tubes 122 and 123. Therefore, even if the electric power lines 125a and 125b are provided separately, it is possible to save the space in a vertical direction in the display 100 shown in FIG. 13A. In other words, if the length of the display 100 is determined in a vertical direction, the brightness of the backlight portion 120 can be improved because of the longer portion of the fluorescent tube 122. The electric power line 126 connected from the ground electrodes of the fluorescent tubes 122 and 123 is commonly connected and then provided. It is therefore possible to arrange one ends of the fluorescent tubes 122 and 123 at a substantially same position. This makes it possible to make the fluorescent tubes 122 and 123 as long as possible, thereby further improving the brightness of the backlight portion 120.

The display apparatus employed in the first exemplary embodiment is a multi-view display apparatus on which the first image and the second image are respectively visible from different viewing directions on a common display screen. In the multi-view display in which the brightness of the backlight portion is demanded to be increased, the brightness of the backlight portion 120 can be enhanced without increasing the width of the chassis 105, as viewed from the front surface.

Also, in a case where there is provided the parallax barrier 115 so that the first image and the second image are respectively visible from different viewing directions, the light for the first image and that for the second image are approximately ½ of the overall light. So, the brightness of the backlight portion 120 is demanded to be further improved. In the display apparatus in which the brightness of the backlight portion 120 is demanded to be further improved, the brightness of the backlight portion 120 can be improved without increasing the width of the chassis 105, as viewed from the front surface.

In the first exemplary embodiment, the description has been given of an in-vehicle liquid crystal display apparatus having a multi-view display. However, the present invention is not limited thereto. The same effect is obtainable by applying to an in-vehicle display apparatus in which the size thereof has to be predetermined as viewed from the front surface. The description has been given of an example in which two fluorescent tubes are provided. However, the present invention is applicable to a case where three or more fluorescent tubes are provided. Also, the fluorescent tube having any cross-section other than a circular cross-section may be employed as the light-emitting part. In addition, a white LED or the like may be employed for the light-emitting part. Furthermore, it is preferable that the light guide plate 121 should be made of a material that uniforms the light on the whole surface. For example, minute grooves having V-shaped cross-section may be provided on the surface of the light guide plate 121.

### Second Exemplary Embodiment

A description will now be given of a second exemplary embodiment of the present invention. In the second exemplary embodiment, the first image and the second image are respectively visible from different viewing directions on a common display screen, in which the brightness of the backlight portion 120 is demanded to be further improved. In a case where the fluorescent tubes 122 and 123 serve as a light source of the backlight portion 120 in the first exemplary embodiment, heat developed in the fluorescent tubes 122 and 123 is increased. Hence, heat release has to be considered, and this increases the size of the display 100. Nevertheless, for example, the in-vehicle liquid crystal display apparatus is, in most cases, arranged in a dashboard part between the driver's seat and the front-passenger's seat, and is needed to have a predetermined size. Accordingly, the brightness of the backlight portion is demanded to be enhanced without increasing the size of the in-vehicle liquid crystal display apparatus or without increasing the heat developed therein.

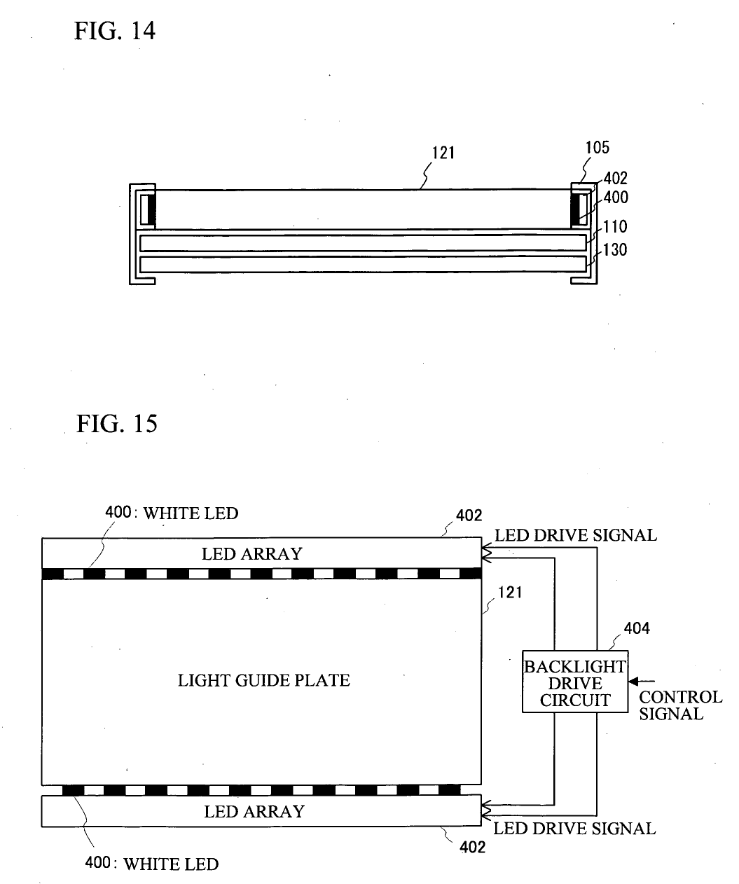

FIG. 14 is a cross-sectional view of the display 100 of the display apparatus in accordance with the second exemplary embodiment. As compared to FIG. 11C, the fluorescent tubes 122 and 123 are replaced by LED arrays 402 having white color Light-Emitting Diodes (LEDs) 400. Other configurations are same as those shown in FIG. 11C, and the same components and configurations as those shown in FIG. 11C have the same reference numerals and a detailed explanation will be omitted. Referring to FIG. 14, the LED arrays 402 having multiple white LEDs 400 are arranged at both sides, namely, at left and right sides of the light guide plate 121. FIG. 15 is a front view of the backlight portion 120 in accordance with the second exemplary embodiment. FIG. 15 shows the LED arrays 402 provided on top and bottom surfaces. Referring to FIG. 14 and FIG. 15, the LED arrays 402 may be provided either on the top and bottom surfaces or at the left and right sides, that is, at opposing sides of the light guide plate 121. The white LEDs 400 are connected in series or in parallel in the LED array 402.

Referring to FIG. 15, LED drive signals are supplied in parallel to the LED arrays 402 respectively provided on the top and bottom surfaces from a backlight drive circuit 404. A control signal is supplied to the backlight drive circuit 404. The control signal is a signal that controls high and low in brightness or on/off of the backlight portion 120. The LED drive signal is a signal that drives the white LEDs 400.

The LED drive signal is output to the LED arrays 402 from the backlight drive circuit 404, by the control signal. This lights the white LEDs 400. As shown in FIG. 14, the light of the white LED is guided through the light guide plate 121, passes through the liquid crystal panel 110 and the touch panel 130, and is then emitted from the surface of the display 100.

As described, the brightness of the backlight portion 120 can be improved, as compared to the first exemplary embodiment, without increasing the thickness of the light guide plate 121, by employing the white LED serving as the light-emitting portion of the multi-view display on which the first image and the second image are respectively visible from different viewing directions on a common display screen 102. It is therefore possible to improve the brightness of the backlight portion 120 without increasing the size of the display apparatus. In addition, the white LED is smaller in heat developed therein than that developed in the fluorescent tube, thereby improving the brightness of the backlight portion 120 without increasing the size of the display apparatus. Furthermore, no high-voltage part is necessary for the white LED, whereas a high-voltage part such as an inverter is necessary for the fluorescent tube. Accordingly, the size of the display apparatus can be reduced. Also, the brightness is not decreased in the white LED at low temperature, whereas the brightness is decreased in the fluorescent tube at low temperature.

In the second exemplary embodiment, the LED arrays 402 are provided at two sides of the light guide plate 121. However, one or more LED arrays 402 may be provided at only one side, three side, or four sides. In the second exemplary embodiment, as shown in FIG. 15, the white LEDs opposing each other are alternately arranged. In this manner, the uniform brightness is obtainable on the whole backlight portion 120 by arranging the light axes of the white LEDs in a shifted manner. In order to retain the design flexibility in the arrangement of the LED array 402, a mirror, optical fiber, prism, or the like may be provided between the LED array 402 and the light guide plate 121. Also, a pulse signal may be employed for the LED drive signal to reduce the power consumption.

In the above-described exemplary embodiments, the description has been given of the liquid crystal display apparatus mounted in a vehicle as an example. However, the present invention is not limited thereto, and is applicable to any display apparatus other than the in-vehicle liquid crystal display apparatus.

The description heretofore has been given of a case where the driver sits on a right-hand side in an automobile and the front-seat passenger sits on a left-hand side, however, the present invention is not limited thereto. The driver may sit on a left-hand side and the front-seat passenger may sit on a right-hand side in an automobile.

The present invention is not limited to the above-mentioned exemplary embodiments, and other embodiments, variations and modifications may be made without departing from the scope of the present invention.

The present invention is based on Japanese Patent Application No. 2005-274790 filed on Sep. 21, 2005, and Japanese Patent Application No. 2006-071033 filed on Mar. 15, 2006, the entire disclosure of which is hereby incorporated by reference.

What is claimed is:

1. A display apparatus comprising:
a display panel that displays individual images in a plurality of viewing directions on a common screen;
a parallax barrier that makes the individual images respectively visible from the plurality of viewing directions;
a light guide plate provided on a back surface of the display panel; and
a plurality of light-emitting portions arranged at one or more sides of the light guide plate,
wherein the plurality of light-emitting portions are arranged in a line in a thickness direction of the light guide plate.

2. The display apparatus as claimed in claim 1, wherein a width of the light guide plate in the thickness direction is greater than a total of thicknesses of the plurality of light-emitting portions and a distance between the plurality of light-emitting portions.

3. The display apparatus as claimed in claim 1, wherein the plurality of light-emitting portions are arranged at one of the sides in a longitudinal direction and at one of the sides perpendicular to the longitudinal direction.

4. The display apparatus as claimed in claim 1, wherein the plurality of light-emitting portions are formed in a substantially U shape.

5. The display apparatus as claimed in claim 4, wherein each of the plurality of light-emitting portions formed in the substantially U shape is a bent fluorescent tube.

6. The display apparatus as claimed in claim 1, wherein one of the plurality of light-emitting portions is different in length from the rest of the plurality of light-emitting portions.

7. The display apparatus as claimed in claim 6, wherein ends of the plurality of light-emitting portions are substantially located at an identical position.

8. The display apparatus as claimed in claim 1 further comprising a display controller that outputs the individual images on the display panel.

9. A display apparatus comprising:
a display panel that displays individual images in a plurality of viewing directions on a common screen;
a parallax barrier that makes the individual images respectively visible from the plurality of viewing directions;
a light guide plate provided on a back surface of the display panel; and
a plurality of light-emitting diodes arranged at opposing sides of the light guide plate,
wherein light axes of the plurality of light-emitting diodes arranged at one side of the opposing sides are shifted from the light axes of the plurality of light-emitting diodes arranged at the other side of the opposing sides.

10. The display apparatus as claimed in claim 9 further comprising a display controller that outputs the individual images on the display panel.
